(19) United States
(12) Patent Application Publication
(10) Pub. No.: US 2003/0034958 A1
(43) Pub. Date: Feb. 20, 2003

(54) System and device for assisting flight scheduling by a traveler

(76) Inventors: Anders Waesterlid, Huddinge (SE); William E. Clark, Hillsborough, NC (US)

Correspondence Address: COATS & BENNETT, PLLC, P O BOX 5, RALEIGH, NC, 27602, US

(21) Appl. No.: 10/192,370

(22) Filed: Jul. 10, 2002

Related U.S. Application Data
(62) Division of application No. 09/453,784, filed on Dec. 3, 1999, now abandoned.

(51) Int. Cl. G09G 5/08

(52) U.S. Cl. 345/158

(57) ABSTRACT

A personal travel assistant for a user includes a wireless communication device adapted to communicate with a base network having flight schedule information relating to a plurality of flights. The travel assistant stores time-based traveler location information, including different time periods and a traveler location associated with each of the time periods. A clock provides the current time for determining a current one of the time periods. A logic unit causes selective communication with the base network to selectively obtain flight schedule information, for example, for a first flight having a flight departure time after the expiration of the current time period, with the current traveler location as originating location, and the traveler next destination as destination location.

### BACKGROUND OF THE INVENTION

1. Technical Field

The present invention is directed toward a system and device for assisting a traveler, and more particularly toward a system and device for assisting a traveler in scheduling airline travel.

2. Background Art

Travelers, particularly business travelers, typically follow a schedule or itinerary to assist them in being where they need to be when they need to be there. However, unscheduled events can cause such travelers to get off their schedule, causing conflicts between scheduled events and difficulties in traveling from one location to another on a timely basis. As such, travelers are frequently subjected to delays which can make them late for a subsequent event, or to cancellations and shorter than expected events which can leave them with idle time in uncomfortable locations with nothing to do.

Typically, travelers have no convenient way of managing their travel information while traveling. Such travelers use manual methods such as pieces of paper, or through rudimentary phone books stored in mobile phones allowing them to call travel agencies or secretarial staff when scheduling changes occur. Self contained devices for keeping such information have also been used.

A few portable communication devices have been developed to assist such travelers. For example, U.S. Pat. No. 5,237,499 shows a system for assisting groups of travelers for planning trips. Also, U.S. Pat. No. 5,459,859 discloses a system and device for assisting travelers in coordinating schedules among a group of travelers, and U.S. Pat. No. 5,790,974 discloses a device for assisting a traveler in coordinating and updating his/her schedule with travel times between events on the schedule using location information as received by a GPS receiver interface.

While the above prior systems can be useful in assisting a traveler, they do not address many issues which may arise for a traveler, including particularly the information needs for persons who encounter schedule changes or delays on a trip involving traveling by commercial airlines. Such travelers are often particularly hurried and in need of quick information about flight times so that they can quickly change not only flight tickets but also subsequent events on their schedule based on those flight times. Of course, flight schedules are published in paper form, but such publications can be bulky (a particular disadvantage to a traveler who is already carrying heavy baggage), easy to lose track of in luggage, and difficult to read and use. Further, even if a user is able to find and properly use such publications while on his trip, such publications may well be out of date and, even if up to date, cannot keep track of real time flight information (for example, delayed departures).

The present invention is directed toward overcoming one or more of the problems set forth above.

### SUMMARY OF THE INVENTION

In one aspect of the present invention, a personal travel assistant for a user is provided, including a wireless communication device adapted to communicate with a base network having flight schedule information relating to a plurality of flights and including originating location, destination location and flight departure time for each such flight, a memory, a clock, a logic unit, a display unit and a display control. The memory is adapted to store travel related information of a travel itinerary of the user, the travel itinerary having different time periods and a traveler location associated with each of the time periods. The clock keeps a current time for determining a current one of the different time periods. The logic unit is adapted to cause selective communication of the wireless communication device with the base network to selectively obtain flight schedule information for a first flight having a flight departure time after a selected time, the current traveler location as originating location, and the traveler next destination as destination location. The display control causes the display unit to selectively display the selectively obtained flight schedule information, the flights of the selectively obtained flight schedule information having the same originating location as the traveler location associated with the current one of the different time periods and flight departure times after the selected time.

In a preferred form of this aspect of the invention, a manual input is provided for the display control for controlling which of the selectively obtained flight schedule information is displayed on the display unit.

In another preferred form, the logic unit is further adapted to cause selective communication of the wireless communication device to selectively obtain flight schedule information for a second flight having a flight departure time next after the flight departure time of the first flight, the current traveler location as originating location, and the traveler next destination as destination location, where the display control is adapted to selectively cause the information display to display selected portions of the flight schedule information of the second flight. In other preferred forms, the memory is adapted to store flight schedule information for the first and second flights, and the display control includes a manual input for causing the information display to change between the flight schedule information of the first and second flights.

In still another preferred form of this aspect of the invention, the time periods of the travel itinerary have an end time as the scheduled departure time of the traveler from the location of that time period, and the first flight has a departure time after the end time of the current one of the different time periods.

In yet another preferred form, the first flight is the flight which has the first departure time after the end time of the current one of the different time periods.

In still another preferred form, the wireless communication device further includes a manual input for activating the logic unit to cause the selective communication with the base network.

In another aspect of the present invention, a flight travel assistance system for a traveler is provided, including a base network and a mobile wireless communication unit adapted to communicate with the base network. The base network includes flight schedule information, the flight schedule information relating to a plurality of flights and including originating location, destination location and flight departure time for each such flight. The mobile wireless communication unit includes an information display, a clock for determining time, a memory for storing a user travel itinerary, a logic unit adapted to cause selective communication with the base network, and a display control adapted to cause the information display to display selected information. The travel itinerary stored in the memory has time-based traveler location information including current traveler location and traveler next destination. The logic unit causes the communication unit to selectively obtain next flight schedule information for a flight having a flight departure time next after a specified time, the current traveler location as its originating location, and the traveler next destination as its destination location. The displayed selected information is selected portions of the next flight schedule information.

In one preferred form of this aspect of the invention, the logic unit is a synchronizer adapted to update the memory with the selected travel related information relevant to the travel itinerary.

In another preferred form, the base network further includes the travel itinerary, and an input is provided for selectively revising the travel related information of the travel itinerary.

In still another preferred form, the logic unit is further adapted to cause selective communication with the base network to selectively obtain subsequent flight schedule information for a flight having a flight departure time next after the flight departure time of the next flight schedule information displayed on the information display, the current traveler location as originating location, and the traveler next destination as destination location, with the display control adapted to cause the information display to display selected portions of the subsequent flight schedule information. In other preferred forms, the memory is adapted to store next flight information and subsequent flight information, and the display control includes a manual input for causing the information display to change between the next flight schedule information and the subsequent flight schedule information.

In yet another preferred form, the mobile wireless communication unit further includes a manual input for activating the logic unit to cause the selective communication with the base network.

It is an object of the invention to provide reliable assistance to itinerary travelers who travel by commercial airline.

### BRIEF DESCRIPTION OF THE DRAWINGS

FIG. 1 is an illustration of a wireless communication device embodying the present invention;

FIG. 2 is a flow chart illustrating one method of employing the present invention; and

FIG. 3 is a chart of a communication network according to the present invention.

### DESCRIPTION OF THE PREFERRED EMBODIMENT

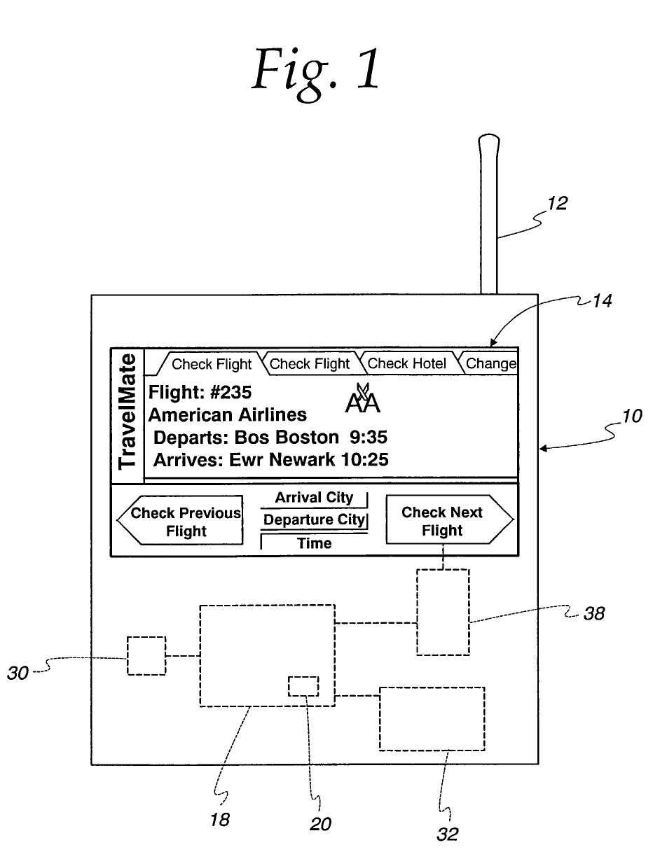

A mobile communication device 10 according to the present invention is illustrated in FIG. 1. The device 10 includes suitable wireless communication components such as the illustrated antenna 12, and is preferably a cellular device as is well known in the art. For example, the device 10 may be a cellular telephone, with a suitable speaker, microphone, keypad, etc. as is well known in the art and not shown in FIG. 1.

The device 10 also includes a suitable information display 14, which in a preferred embodiment can also serve as a user input by provision of a suitable touch sensitive face such as is also known in the art and as discussed further below.

A processor 18 for handling communicated information is further included, which processor 18 includes a logic unit 20 adapted to cause selective communication with a base network 24 as also further described below. The processor 18 and logic unit 20 work in conjunction with a clock 30 for determining time and a memory 32. A suitable display control 38 is also provided for controlling the information display 14. Suitable display technologies which may be used include the Wireless Application Protocol's Wireless Markup Language, Hyper Text Markup Language (HTMP), Java, Java Script, native implementations or HDML, although it should be understood that this invention is not limited to such display technologies and still others (including technologies not yet developed) could also be used within the scope of the invention once a full understanding of the invention is had.

In accordance with the present invention, the communication device 10 stores the travel itinerary of a user in the memory 32, with the travel itinerary having time-based traveler location information including current traveler location and subsequent traveler destinations. For example, the travel itinerary could include a time block of from noon on the first day of a month until 9:35 p.m. the next day during which the traveler is scheduled to be in Boston, with a flight scheduled to leave at the end of that time block for Newark. A time block could also then be included in the itinerary from the arrival time in Newark (for example, 10:25 p.m.) until a subsequent departure time from Newark.

With such a travel itinerary in the device memory 32, the processor 18 recognizes based on the time from the clock 30 which time block the traveler is in. In the example given, for example, if the clock 30 indicates that it is prior to 9:35 p.m. on the second day of the month, the processor will recognize that the user is in the Boston time block. Recognizing this, the processor 18 will, with the display control 38, cause the information display 14 to show the flight scheduled in the travel itinerary for the end of that time block.

The present invention is adapted to provide assistance to the traveler if, as frequently occurs, the traveler may not be able to conform to the predetermined flight travel on his/her itinerary.

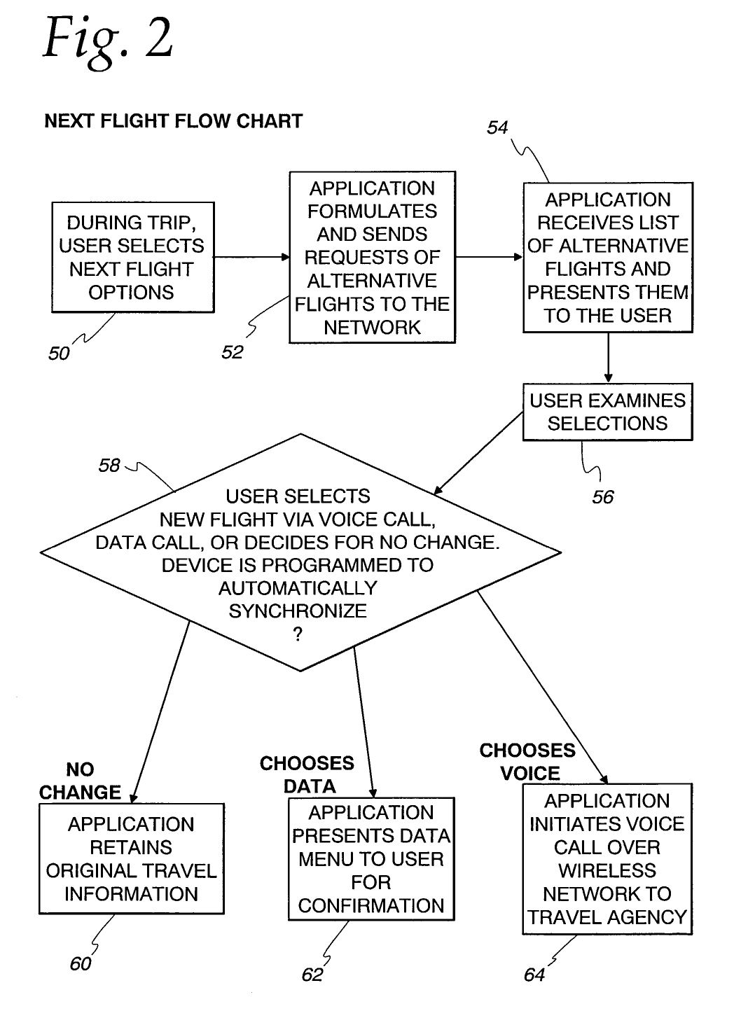

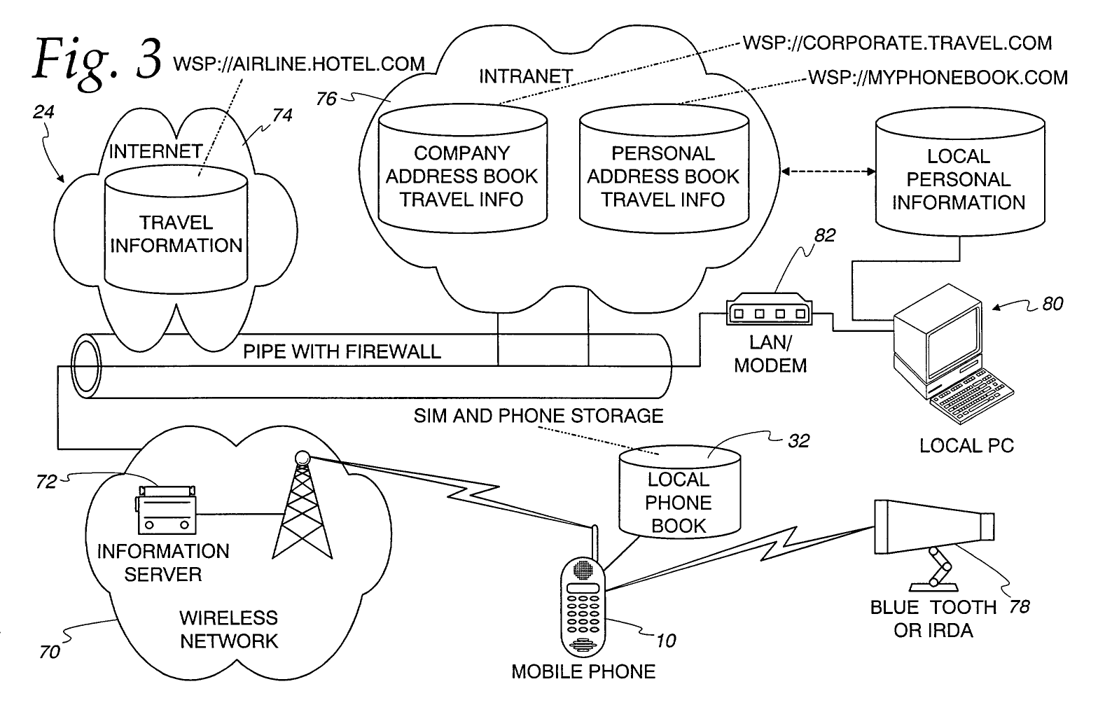

Specifically, if a traveler determines that he/she will be delayed so that he/she will not be able to make the scheduled flight, he/she may select the Next Flight option on the communication device 10 as illustrated in FIG. 2 (box 50). This selection may be made by touching the touch sensitive screen on the portion with the “Check Next Flight” icon displayed thereon. Since, in the example used herein, the clock 30 indicates a time which is in the time block which the stored itinerary indicates to be in Boston, and which the itinerary also indicates is to be followed by a time block in Newark, the processor 18 and logic unit 20 will formulate and send a request of alternative flights (box 52) to the base network 24 (as discussed further below in connection with FIG. 3) for scheduled airline flights from Boston to Newark after the traveler's scheduled flight.

The base network 24 responds via wireless communication to the traveler's communication device 10 with information regarding the requested alternative flights (box 54), and the information is intelligently cached in the memory 32. (Similarly, if the traveler is completing business early, the traveler may obtain information about earlier flights by touching the “Check Previous Flight” icon, in which case the processor 18 and logic unit 20 will send a request for information on flights before the traveler's scheduled flight).

In the preferred embodiment, given the greater processing capacities of the base network 24, the information is formatted appropriately prior to communicating it to the device 10. It should be recognized, however, that it would be in the scope of the invention if the information is formatted as needed by the device processor 18.

Information on a selected number of flights may be communicated in response to a request from the device 10, depending upon the memory 32 available in the device 10 for caching such information.

The processor 18 in cooperation with the display control 38 then causes the information display 14 to display information (e.g., flight departure time, airline, departure airport, destination airport, destination time) about the “next flight”. The traveler may then observe that displayed information (box 56) and decide what he/she wishes to do (box 58). If the traveler does not wish to change his/her original schedule, he/she may do so and take no further action (box 60) in which case his/her original ticketing will remain unchanged. If the traveler wishes to change to a different flight, he/she may do so by, for example, touching the touch sensitive screen on the portion with the “Change Flight” icon displayed thereon. At that point, the display 14 will indicate the options available to the traveler. For example, the device 10 may allow the traveler to change the flight by either using a data link (box 62), or a voice call (box 64), or may provide the traveler with both options.

With a data link, the information display 14 will, for example, display a flight option with an icon asking whether to “Confirm Change to This Flight”. By touching this icon (or otherwise providing input to indicate this choice), the traveler causes the processor 18 and input logic 20 to communicate with the base network 24 to reserve a seat on that flight for the traveler and to cancel the traveler's original reservation on a different flight.

Alternatively, by choosing a voice call option, the information display 14 will be caused to institute a wireless voice call to an appropriate location where flight reservations may be made. For example, a travel agency used by the traveler may be automatically called (without need for the traveler to look up and enter the number), or calls to the airlines themselves may be initiated. In the later case, the device memory 32 may include several airline numbers, with the processor 18 causing the airline of the desired flight to be called.

FIG. 3 illustrates a variety of methods by which the device 10 of the present invention may communicate with a base network 24 to enable it to automatically obtain additional information such as indicated above.

For example, the device 10 may communicate with a wireless network 70 (such as a cellular telephone system) which includes or is otherwise connected to an information server. That is, the network may itself be provided with its own information server 72 which has the information responsive to the request of the device 10, or may be connected to a suitable server such as the Internet 74 or a private Intranet 76 which includes such information. Alternatively, the device may communicate with private wireless systems via short wave or infrared communication such as Bluetooth and IrDA systems 78. Such alternate systems may then provide a suitable connection to the required information (e.g., either by including the information in a private PC 80 in the network, or by suitable connection, such as through local area network or modem 82, to a suitable server which does have the information such as the Internet 74 or a private Intranet 76).

It should be recognized, however, that the most up to date information for flights will typically not be maintained on a private network, but rather will most likely be maintained on a more broadly available service such as the Internet 76 (where each airline and/or the FAA are likely to keep real time information about flights), so that while any suitable connection to such information is possible, the most timely flight information will most likely be found by connection to the Internet 76. For example, if a flight has been delayed, or is canceled, or is sold out, such information (which will most likely be available from the airlines' own Internet sites) may also be used to ensure that the traveler be provided with the most helpful information. For example, a sold out flight could be skipped in informing the traveler of the next flight (or at least an indication to that effect be provided to allow the traveler to decide for himself/herself where to attempt to get on it), or a delayed flight departure might provide the traveler with a convenient flight which the traveler might otherwise think he/she could not catch based on the scheduled departure time.

It should also be recognized that the wireless communication technology used need not be limited to those mentioned above, nor is the technology of transporting the information limited. For example, while WAP Session and/or Transport Layers may be used, still other technologies, including those not yet developed, may be used within the scope of the present invention so long as those technologies permit the wireless communication of the information used in accordance with the invention as described herein.

It should be recognized that the device 10 could also communicate with the base network 24 for other advantageous purposes. For example, the device 10 could obtain information about the traveler's itinerary and display that information to assist the traveler. For example, “On Time” or “Delayed” indications could be displayed on the display 14 according to the status of the traveler's next scheduled flight based on periodic information requests from the device 10 to the base network 24. Further, if the traveler's itinerary changes, such changes could be input (either in the base network 24 or in the device 10) and the changed itinerary synchronized between the device 10 and the network 24. This is particularly helpful where extensive data input into the device 10 is difficult (due to a typical lack of full keyboard) but the traveler's secretarial staff at his/her home office may easily make such itinerary changes, with such changes thereby automatically (or by user input) synchronized in the traveler's device. Such synchronized changes can also be maintained when a flight schedule is changed in accordance with the invention as discussed above.

The device 10 may also be used to provide the traveler with other information based on his/her itinerary and the time, for example, hotel numbers and information for the area where you are scheduled to spend that night, and/or local taxi companies, restaurants, car rental companies, etc. with the device 10 automatically calling (without user input of the number) to contact any of them (e.g., for reservations or directions).

The device 10 may also be set so that the processor 18 will use the time determined by the clock 30 and, with the location information for that time as determined from the traveler's itinerary, automatically change the clock 30 to display the time according to the local time zone.

It should thus be appreciated that the present invention will provide a traveler with context-sensitive information based on the current time and his/her scheduled travel. Still further, the device 10 according to the present invention provides the traveler information which may be quickly and reliably updated periodically, either automatically or upon user demand. Still further, such information will be provided to the user in a manner which is easy to browse, and which will be available even when communication with the network is lost.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A flight travel assistance system for a traveler, comprising:
a base network including flight schedule information, said flight schedule information relating to a plurality of flights and including originating location, destination location and flight departure time for each such flight;
a mobile wireless communication unit adapted to communicate with the base network and including
an information display,
a clock for determining time,
a memory for storing a user travel itinerary, said travel itinerary having time-based traveler location information including current traveler location and traveler next destination;
a logic unit adapted to cause selective communication with said base network to selectively obtain next flight schedule information for a flight having
a flight departure time next after a selected time,
said current traveler location as its originating location, and
said traveler next destination as its destination location, and
a display control adapted to cause said information display to display selected portions of said next flight schedule information.

2. The system of claim 1, wherein said logic unit is a synchronizer adapted to update said memory with said selected travel related information relevant to said travel itinerary.

3. The system of claim 1, wherein said travel itinerary includes scheduled flights of said traveler, and said selected time is a departure time of the next flight in the user travel itinerary.

4. The system of claim 1, wherein said base network further includes said travel itinerary, and including an input for selectively revising the travel related information of said travel itinerary.

5. The system of claim 1, wherein:
said logic unit is further adapted to cause selective communication with said base network to selectively obtain subsequent flight schedule information for a flight having
a flight departure time next after the flight departure time of said next flight schedule information displayed on said information display,
said current traveler location as originating location, and
said traveler next destination as destination location; and
said display control is adapted to cause said information display to display selected portions of said subsequent flight schedule information.

6. The system of claim 5, wherein said memory is further adapted to store next flight schedule information and subsequent flight schedule information, and said display control includes a manual input for causing said information display to change between said next flight schedule information and said subsequent flight schedule information.

7. The system of claim 1, wherein said mobile wireless communication unit further includes a manual input for activating said logic unit to cause said selective communication with said base network.

8. A personal travel assistant for a user, comprising:
a wireless communication device adapted to communicate with a base network having flight schedule information relating to a plurality of flights and including originating location, destination location and flight departure time for each such flight;
a memory adapted to store travel related information of a travel itinerary of the user, said travel itinerary having different time periods and a traveler location associated with each of said time periods;
a clock keeping a current time for determining a current one of said different time periods;
a logic unit adapted to cause selective communication of said wireless communication device with said base network to selectively obtain flight schedule information for a first flight having
a flight departure time after a selected time,
said current traveler location as originating location, and
said traveler next destination as destination location; and
a display unit and display control, said display control causing said display unit to selectively display said selectively obtained flight schedule information, said flights of said selectively obtained flight schedule information having the same originating location as said traveler location associated with said current one of said different time periods and flight departure times after said selected time.

9. The personal travel assistant of claim 8, further comprising a manual input for said display control for controlling which of said selectively obtained flight schedule information is displayed on said display unit.

10. The personal travel assistant of claim 8, wherein said travel itinerary includes scheduled flights of said traveler, and said selected time is a departure time of the flight in the user travel itinerary at the end of the current one of said different time periods.

11. The personal travel assistant of claim 8, wherein:
said logic unit is further adapted to cause selective communication of said wireless communication device to selectively obtain flight schedule information for a second flight having
a flight departure time next after the flight departure time of said first flight,
said current traveler location as originating location, and
said traveler next destination as destination location; and
said display control is adapted to selectively cause said information display to display selected portions of the flight schedule information of said second flight.

12. The system of claim 11, wherein said memory is further adapted to store flight schedule information for said first and second flights, and said display control includes a manual input for causing said information display to change between the flight schedule information of the first and second flights.

13. The personal travel assistant of claim 8, wherein the time periods of the travel itinerary have an end time as the scheduled departure time of the traveler from the location of that time period; and
said first flight has a departure time after the end time of the current one of said different time periods.

14. The personal travel assistant of claim 8, wherein said first flight is the flight which has the first departure time after the end time of the current one of said different time periods.

15. The personal travel assistant of claim 8, wherein said wireless communication device further includes a manual input for activating said logic unit to cause said selective communication with said base network.
